(19) United States
(12) Patent Application Publication
(10) Pub. No.: US 2001/0019926 A1
(43) Pub. Date: Sep. 6, 2001

(54) Flexible stamped tab with electrical contact points

(76) Inventor: Gianfranco Natali, Lugano (CH)

Correspondence Address: DENNISON, MESEROLE,, POLLACK & SCHEINER, 1745 Jefferson Davis Highway, Suite 612, Arlington, VA, 22202, US

(21) Appl. No.: 09/793,511

(22) Filed: Feb. 27, 2001

(30) Foreign Application Priority Data
Mar. 3, 2000 (IT) AR2000A000011

(51) Int. Cl. H01R 4/48

(52) U.S. Cl. 439/862

(57) ABSTRACT

The invention consists of a tab (1), projecting from a plate (2) equipped with an elongated stiffener (11) placed just next to the point in which the tab projects from the body of the plate and a drawn hole (14) or a deformity obtained by stretching and compressing/flattening (20,21) since there is a protective insulating coat on the plate (25); this hole or deformity is placed at the free end of the tab (1 producing the uncoated surface for the electrical contact.

### BACKGROUND OF THE INVENTION

The invention relates to a flexible stamped plate tab with electrical contact points, through which coupled plate structures or parts producing box-shaped structures used to house electric circuits and electronic circuits in particular, can also form closed electric circuits. Said circuits can originate a shield against electromagnetic radiations in the same way of a Faraday's cage.

In particular, in the electronic equipment field there are box-shaped plate structures with shaped and flexible outward projecting tabs. These tabs aim is to determine a mechanical contact with other structures corresponding tabs or surfaces designed to be coupled with. Usually the mechanical contact aim is to originate an electrical contact guaranteeing a metal contact continuity that brings the two coupled structures to the same electric tension, for example the earthing one, or allows the electric current circulation in a way that makes the above-mentioned box-shaped structures similar to Faraday's cage. This system will block the irradiation towards the outside of the electromagnetic fields produced inside the box-like structures, or the interference with the electric and electronic circuitry housed inside said structures from the electromagnetic fields existing in the environment.

The above mentioned flexible tabs for electric contact have been used since 1987 by the applicant of the present invention in the production of box-shaped metal structures for computers made of galvanized or in any case not pre-painted plate. The tabs—that protrude from the edge of the structures on which they are obtained, or project into some openings that exist on the same structure on which they are obtained—guarantee the mechanical contact with the part of or the entire structure that bends them as a consequence of the flexible quality of the plate from which they are made.

When this plate is previously painted or coated with a layer of electrically non-conductive material, the electric contact is impeded.

In some applications this inconvenience has been overcome by using plates previously painted only on one side.

In this case the tab is relatively long constructed and it is bent at its free end to acquire an undulated shape, so that the non protected surface protrudes from this end, allowing the tab to operate the electric contact required.

The flexibility of said inflection, thanks to which the tab maintains the mechanical contact with the surface or the corresponding tabs of the piece or structure with which it interacts mechanically, is usually due to the specific flexibility of the plate with which it is obtained.

When the use of plates with a higher degree of malleability is necessary, at the expense of their flexibility, this flexibility can be obtained in the required measure with other appropriate systems. Using plates that are less malleable and then more flexible, previously painted and thus pre-protected only on one side, is only a partial solution to the problem. In fact, sometimes, it is necessary to have an electric contact just on the paint protected surface because of technical and aesthetic reasons.

Said limitations were overcome in 1995 with the pre-painted flexible electric contact tab that was the object of the German Patent DE19507846 C1. In this patent the tab is obtained on a pre-painted plate and can engage in electrical contact with another tab of the same type or with a not electrically insulated surface. It is usually cut-out from the plate, meaning it is trimmed on three sides so that it is housed in the opening on the plate from which it is obtained.

Its flexibility is a consequence of the cold flattening process of one section of its length. Its end is then 90° bent to bring the conducting border surface, where the trimming was carried out in order to obtain the tab, towards the contact point.

In this solution, the tab's most exposed surface—the one through which the mechanical and electrical contact occurs with the surface of another non protected plate structure is the trimmed edge, whose width is equal to the thickness of the plate from which the tab is made. Therefore, this surface is not protected by paint and allows the required electrical contact.

Said tab presents its most protruding end, where the mechanical and electrical contact occurs, clearly bent over at 90° towards the final part. This way exposing the surface where the tab has been trimmed. The protruding ends bent in this way as may become catching points—when the structures which contain them are being worked on,—against which other parts or structures can collide, with consequent deformities or damages, that make them useless. These bent edges can also accidentally brush against the person working on them causing cuts, bruises or other physical damage.

Another disadvantage of these tabs is due to the fact that to work harden them, a section of their length is flattened out; on the one hand this makes them flexible and elastic, but on the other it weakens them mechanically. This may cause permanent deformities when accidental above normal tensions/touching occur.

A further inconvenience is due to the fact that it is difficult to carry out the bend at the end of the tab because of the limited free space which is usually available around it on the plate from which it is made. The operation is therefore complex and requires expensive equipment.

### SUMMARY OF THE INVENTION

The aim of the present invention is to create a tab that protrudes from a plate, which is projecting from a reference plane, normally the plate itself which the tab is obtained from, in order to be orientated towards a corresponding tab or a surface of a structure or part of it coupled with the structure from which the tab emerges.

Another aim of this invention is to create a tab that can react in a flexible way to bends to ensure in the long run the preservation of the mechanical contact with the surface it must adhere to.

One more aim of this invention is to create a mechanically resistant tab, able not be easily damaged by abnormal tensions/stress compared to the standard ones.

One more aim of this invention, if the plate from which the tab is made is pre-painted, is that the most protruding end of the tab, where the mechanical contact with the corresponding surface is expected to occur, is not painted nor provided with another insulating protective coat. This is necessary to make not only the mechanical contact but also the electrical one between the corresponding parts of the coupled structures or parts possible.

One more aim of this invention it to obtain the means able to carry out the electrical contact, said means having an appropriate protrusion from the body of the tab from which they are made and not having clear sharp bends. This is necessary to avoid catching problems and incisions on parts that may rub against it and in particular to avoid cuts and bruises on who uses it.

The invention which has made it possible to obtain said results consists of a tab, protruding from a plate or within an opening on the plate on which it is obtained. Said tab is equipped with an elongated stiffener placed just next to the point in which the tab projects from the body of the plate. When there is a protective insulating coat over the plate, said tab will be equipped with a drawn hole or a specific deformity obtained by stretching and/or flattening, both placed at the free end of said tab and both used to obtain the uncovered surface for the electric contact.

The elongated stiffener is obtained through a plastic deformity of the metal which involves the plate and the stem or the initial part of the tab which emerges from said plate.

Said stiffener is like one or more cantilevers which gives resistance and flexibility to the tab on which they are, and, as exemplifying and non limiting examples, it can be obtained with:

a longitudinal drawn deformity;

a longitudinal rib;

a longitudinal swell;

a longitudinal and a transversal draw, with the last one involving only the plate from which the tab projects.

In one of the embodiments, the uncovered surface for electrical contact is made with a drawn hole on it, through which the surface where the mechanical contact occurs is made conductive. Said solution provides for a small hole, placed towards the free end of the tab, on which by the pushing action of a punch and the contrasting action of a matrix of suitable shape and size, a draw and the rolling and slipping process of the metal inside the drawn hole is carried out. Said process forms a truncated cone which projects from the tab at the top of which the metal is transferred by slipping to the tip. Said metal has therefore lost the insulating coat and is thus electrically conductive.

In a different embodiment, the deformation by stretching and/or flattening of the metal is carried out on the point or area of contact. In one case said deformity consists of a draw of one or more short metal strips that are pushed to protrude from the surface of the tab and are then dilated through a stretching and flattening process, causing the protective insulating coat to crack and peel off. Through this process the tips obtained by deforming small sections of the contact surfaces are electrically conductive.

In another case, there is at first a localized flattening on one point, this way process wearing down the protective insulation, then a drawn deformity with which the projection is formed and the layer of coating is on that spot made to come off, exposing the protruding surface from where the protection has come off.

The object of this invention is particularly advantageous in that:

the elongated stiffening of the tab just next to the point where it projects from the body of the plate from which it protrudes, has the double effect of determining both an elevated resistance of said tab to permanent deformities that could occur as a consequence of stress and abnormal accidental tensions, and to confer high flexibility to bends. Said flexibility and resistance are obtained both through the initial section of the body of the tab, and also through the portion of the body of the plate from which it projects and which is involved by the plastic deformation with which said stiffening is obtained;

the elongated stiffening is easily obtainable and does not determine the deformation of the outline of the tab in the case in which it is carried out during a manufacturing stage that precedes the drawing one through which the tab itself is obtained;

the elongated stiffening can involve a variable length of the tab and of the plate from which the tab is obtained; the stiffening can be varied by either modifying the length of the deformity with which it is obtained, by changing the profile of the deformity viewed sideways, or by changing its depth, independently from the shape or outline of the tab on which it is partially placed.

The combination of these factors, meaning the length of the stiffening, its depth, the profile of its section and the shape of the outline of the tab, contribute to obtain a spring effect with different characteristics of flexibility and resistance.

In the case of plates which are not pre-protected by paint or other coating of non electrically conductive material, the tab is shaped and/or bent compared to the level of the plate from which it projects, originating a part which protrudes from the plate itself turned to make contact with a tab, a contact point or a corresponding plate.

In the case in which the plate from which the tab is made is pre-painted, or in any case protected by a coat which is not electrically conductive, the tab is usually flat or slightly bent perpendicularly to the level of the plate, and towards its free end, it has been deformed in order to expose the non-protected metal.

In the case in which the electric contact of the pre-painted tab should be especially aggressive, the deformity and the conductive projection usually have a polygonal shape, for example triangular or quadrangular, in order to have emerging tips or wedges for contact.

The deformities originating the electric contact points, as can be easily understood reading herebelow, are easy to carry out, are not very protruding and are connected to the surface from which they emerge. This makes it difficult for said deformities to catch onto other parts which are made to slide over said tab, and also to avoid cuts and bruises on who works on the structure equipped with said tabs.

### BRIEF DESCRIPTION OF THE DRAWINGS

The structure of the present invention can be easily understood by following the detailed description herebelow and the drawings in the enclosed tables, of which:

FIG. 1 is the plan view of a prior art tab, protruding from the edge of the plate from which it is obtained, one portion of its length is flattened out and thinned down to harden and therefore make the metal more flexible, therefore the tab itself, whereas the end of the tab is 90° bent to bring the trimmed non painted edge to make contact;

FIG. 2 is the sectioned side view of the tab in FIG. 1 protruding inside an opening on the plate from which it is made;

FIG. 3 is the top view of the prior art cut-out tab;

FIG. 4 is the sectioned side view of the tab in FIG. 3;

FIG. 5 is the top view of one of the tabs object of the present invention, in the case in which the elongated stiffening is carried out as a longitudinal draw on the hypothesized not be pre-protected plate;

FIG. 6 is the sectioned side view of the tab in FIG. 5, it highlights the bent end section through which the protruding part for the electric contact is originated;

FIG. 7 is the top view of the tab object of the present invention in the case in which the elongated stiffening is obtained with a longitudinal draw and a transversal draw on a plate which was not previously protected;

FIG. 8 is the sectioned side view of the tab in FIG. 7;

FIG. 9 is the top view of the tab object of the present invention in the case in which the elongated stiffening is carried out with a longitudinal rib, with an impression and swelling, made on a plate which was not previously protected;

FIG. 10 is the sectioned side view of the tab as in FIG. 9 which highlights the impression and one of the two swellings;

FIG. 11 is the top view of the tab object of the present invention, representing the case in which the elongated stiffener is carried out with a longitudinal swell on a plate which was not previously protected;

FIG. 12 is the sectioned side view of the tab represented in FIG. 11;

FIG. 13 is the top view of the tab object of the present invention in the case in which the elongated stiffening is carried out with a longitudinal rib on a previously protected plate, on one or both surfaces, and the contact points are obtained with a drawn hole;

FIG. 14 is the sectioned side view of the tab represented in FIG. 13;

FIGS. 15 and 16 are respectively the top view and the sectioned side view of the tab like the one reproduced in FIGS. 13 and 14, with the drawn hole having a polygonal profile;

FIG. 17 is the top view of the tab object of the present invention in the case in which the elongated stiffening is carried out with a longitudinal rib on a plate previously protected only on the contact side surface and the electrical contact is obtained by bending the end of said tab at 180° (a “U” bend);

FIG. 18 is the sectioned side view of the tab represented in FIG. 17;

FIG. 19 is the top view of the tab object of the present invention in the case in which the elongated stiffening is carried out with a longitudinal rib on a plate previously protected on one or on both surfaces and the electrical contact is obtained by deforming and stretching two short strips placed towards the terminal side of the tab and which originate two dilated and stretched protrusions each one recalling the shape of a half cone;

FIG. 20 is the sectioned side view of the tab in FIG. 19 along the AA section line;

FIG. 21 is the top view of the tab when the longitudinal rib on a plate previously protected on one or on both surfaces and the electric contact is obtained through a dome-like deformity of the plate, by stretching and compressing said plate, through which a protruding point without insulation coating is made;

FIG. 22 is the sectioned side view of the tab represented in FIG. 21;

FIG. 23 exemplifies, by a sectioned view, the process of drawing a hole placed towards the end of the tab, where the punch and the matrix with which it is made are highlighted.

It must be understood that the aim of the drawings is to facilitate the understanding of the invention, and does not constitute in any way a limitation.

### DESCRIPTION OF THE PREFERRED EMBODIMENTS

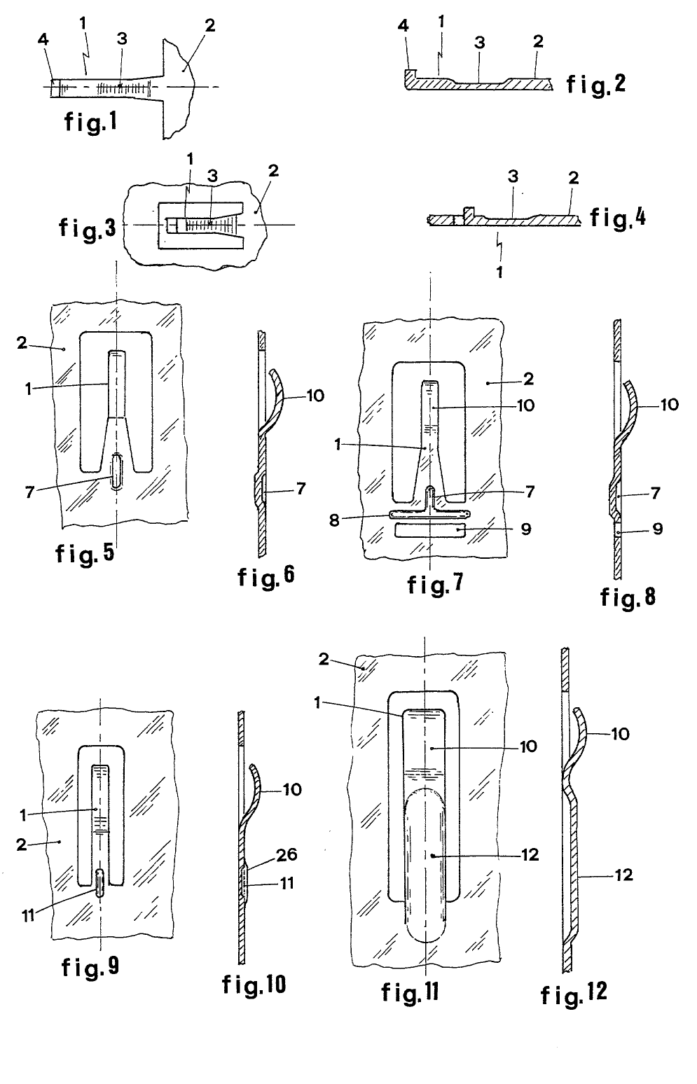

In the drawings representing the prior art, FIGS. 1, 2, 3 and 4, the number 1 indicates the tab, 2 the plate from which it projects, 3 is the section of the tab which has been flattened and thinned out therefore making it flexible through a hardening process of the metal, 4 indicates the 90° bent end towards the point where the electrical contact will occur.

In the subsequent drawings, which represent the object of this invention, numbers 1 and 2 also indicate the tab and the plate from which said tab protrudes, 7 indicates the drawn elongated stiffening, 8 is the transversal draw and 9 is the opening adjacent to the transversal draw, 10 is the part protruding due to the bend of tab 1, in the case in which plate 2 is not previously painted at least on the side where the contact occurs. 11 indicates the ribbed longitudinal stiffening, 12 is the swell-like longitudinal stiffening, 14 is the drawn protrusion, 15 is the non protected metal at the top, 16 is the punch to make it, 17 is the contrasting matrix and, in the exemplified reproduced embodiment 18 indicates the initial hole on plate 2 or on the tab obtained from it which is then drawn. Said initial hole may also be missing and in such a case the plate is torn by punch 16 on the required spot.

Finally, 20 indicates the sheared deformities, which are stretched and compressed and exemplified in FIGS. 19 and 20, whereas 21 indicates the dome-shaped deformity and 22 is the top of said protrusion on which the applied stress caused the detachment and removal of the insulating coat 25, which is represented in the enlarged view of the plate in FIG. 23. In substance, the present invention relates to a flexible stamped tab 1, situated alone or combined with other tabs on a part or structure 2 made of plate. Said tab is equipped with points that are designed to be in mechanical or electrical contact with surfaces of one other part or parts or structures which usually form a box-like shape. Said parts combined together as described are made to be electrically connected and, in some applications, are designed to originate several electrical connections through which the composite structure operates like a Faraday's cage.

Tab 1, object of this invention, is therefore composed of a body protruding from plate 2 on a different level, from which it is made and from which it is usually obtained by shearing and a plastic deformation of the metal. It can also protrude from the edge where the same plate 2 ends, and it can also be placed inside an opening made on plate 2 itself and, in that case it is trimmed on three sides surrounded by an empty space.

Said tab 1 is characterized by a beginning part on which a stiffener is placed over the point where it stems off from plate 2 and one free end which is shaped and formed so as to create the points of mechanical and electrical contact with one part or plate structure, when said plate structure is coupled with the one containing the tab.

The stiffening placed over the point where tab 1 protrudes from the body of plate 2, and through which considerable flexibility is given to tab 1 itself, is obtained by carrying out a plastic deformity of the metal on the part involved, the consequence is that said part then acts as a cantilever. Said solution is particularly ingenious in that the flexible reaction involves the body of tab 1 and also plate 2 adjacent to the section from which the same tab 1 protrudes.

In the embodiment given as example in FIGS. 5 and 6, the stiffening is obtained with a longitudinal draw 7, whose depth, length and width can vary according to the required stiffness and flexibility. In the embodiment given as example in FIGS. 7 and 8 the stiffening is made once again by a drawing process and in particular with a longitudinal draw 7 and a draw 8 which is transversal to the axis of tab 1, in this case a mixed draw with a “T” shape is carried out. In said solution opening 9, adjacent to transversal draw 8 on plate 2, is reproduced, through it the flexible reaction of the metal at the base of the tab and on the two sections connecting the tab to plate 2 when under stress is favored in order to involve in the flexible reaction also a wide section of plate 2 from which tab 1 protrudes.

In the embodiment given as example in FIGS. 9, 10, 13, 14, 15, 16, 17, 18, 19, 20 and 21, 22, the stiffening is carried out by a longitudinal rib 11, whose length, width and depth can be adjusted, and in it the central groove is combined at its sides with two plate swellings 26, acting as stiffening means or beams which determine a strong flexible return when tab 1 is bent by tension.

Whereas, in the solution exemplified in FIGS. 11 and 12 the stiffening is produced by swell 12 which can also vary in length, width and depth, and also involves a section of tab 1 and a portion of the body of plate 2 from where the tab protrudes.

Deformities 7, 11 and 12 are therefore equivalent in that they all carry out the stiffening of tab 1 and enhance its flexible return when it is bent, independently from the fact whether the tab is made from a pre-painted plate 2 or not.

In the case in which plate 2 is not protected by any insulating layer or paint 25 as in the examples reproduced in FIGS. 5, 6, 7, 8, 9, 10 and 11, 12, the body of tab 1, below the elongated stiffening, usually has a shaped profile when compared with the level of plate 2 from where tab 1 protrudes, and with at least one side 10 protruding towards the point where the mechanical and electrical contact is expected to happen with another tab or another plate. The protruding part can be of different shapes also depending on the function of the specific application in which they are used.

In the case in which the plate tab 1 is part of, is protected by an insulating coat 25 distributed only on one surface, in such a case, as exemplified in FIGS. 17 and 18, tab 1 is bent over at 180° (a “U” bend) towards its free end, in order to present the external surfaces at that end, which are both conductive, and therefore allow the required electrical contacts. In this case the body of the tab 1 can also be shaped and therefore protrude compared to the level of plate 2 from which it is made.

In the case in which both surfaces of plate 2 are protected by a non conductive coat or paint 25, the solutions herewith presented do not allow electrical contact. At least in such a situation tab 1 has, at its free end, a deformity of the metal with which the insulating coat 25 is removed locally and therefore uncoated surfaces for electric contact are obtained.

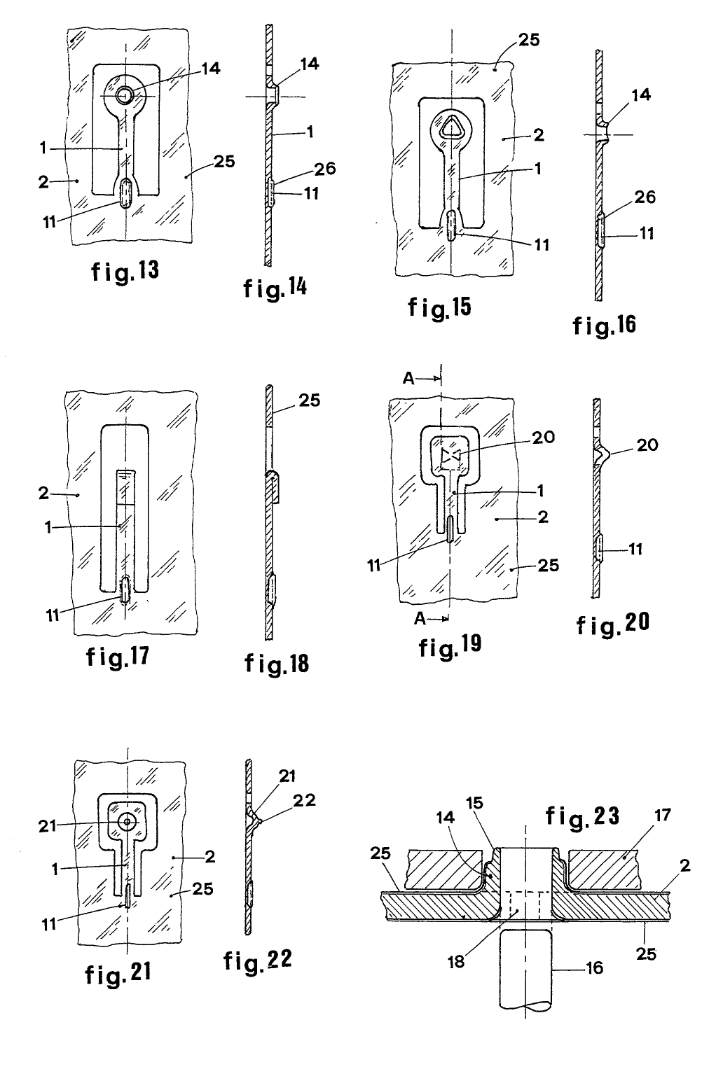

In the exemplifying solution reproduced in FIGS. 13, 14, 15, 16 and 23, tab 1 has a drawn and sheared hole 14 on its free end with the upper edge 15 of metal which is not protected by any insulating layer. Said drawn hole can have a circular edge, or any other profile. The preferred profile is polygonal to make the tips sharper so the electrical contact reached through it is more certain.

FIG. 23, is an exemplifying and not limiting example and indicates the process through which said drawn hole can be made. On plate 2, or on tab 1 made from it, a hole 18 is made, which is pressed to unwrap itself from punch 16 by contrast with matrix 17. Punch 16 is wider than hole 18, therefore as it advances it determines the extrusion of plate 2, and the sliding along of the plate metal on it. The plate is thinned out through a process of rolling-moving along-scraping of the metal near the drawn hole. It is so obtained a truncated cone 14 which protrudes from the tab 1, and at its tip 15 the metal is transferred by sliding along, then it is freed from protections and is therefore conductive.

In the reproduced solution which is only an example in FIGS. 19 and 20, tab 1 has at its free end at least one stretched and compressed tear 20, whose top is defined by an electrically conductive surface. In said solution, in fact, on tab 1 at least one cut is progressively made, therefore a compression on the side of said cut. Consequently, the plate is semi-sheared, deformed, stretched and compressed in order to obtain a half cone. In this way, the stretched plate, near the cut, first causes the cracking of insulating coat 25 and then, continuing with the stretching and compressing process, the layer of insulation 25 is gradually thinned out to finally peel off, this makes the most protruding parts of this deformation electrically conductive. The cut or cuts stretched out and compressed can be one or more and can have any outline profile.

In another solution, exemplified in FIGS. 21 and 22, tab 1 has a conic or dome-like deformity of the plate on its free end. In said deforming process the metal is stretched, and during this process the paint detaches and peels off, therefore the tip is under tension, stretched and or compressed. The protective insulating layer 25 is thus detached on that specific spot, making said surface in said protruding part conductive.

The examples shown illustrate some ways in which tab 1, object of this invention, is rendered conductive near its free end, therefore capable of operating electrical contacts with other tabs or other metal surfaces. As far as the flexibility of the tabs equipped with electrical contacts is concerned, said tabs are carried out will have the stiffening deformity of the metal over their initial part, as shown in any one of the exemplifying solutions described, and will have one or more mechanical and electrical contact points towards the free end, which are also obtained following any one of the described systems. This will depend on the specific needs and on what is required from parts or containing structures, usually box-like structures for machines and electronic equipment made of stamped plate.

The elongated stiffening and the mechanical and electrical contact points made according to the above described techniques on the same tab, can therefore be combined in any way with each other.

1. A flexible stamped plate tab with electrical contact points, consisting of a tab (1) projecting from a plate (2) on which it is obtained, and characterized by an elongated stiffening placed just next to the point where the tab (1) protrudes from the plate (2) and, at least when there is an insulating protective coat (25) on the plate (2), characterized by a deformity of the metal towards the free end of the tab (1) with which the unprotected surfaces of electric contact are made.

2. The stamped tab, as claimed in claim 1, characterized by the fact that the elongated stiffening is placed in a position that involves a section of the tab (1) and a section of the plate (2) from which the tab (1) protrudes.

3. The stamped tab, as claimed in claim 1, characterized by the fact that the elongated stiffening is obtained with a longitudinal draw (7).

4. The stamped tab, as claimed in claim 1, characterized by the fact that the elongated stiffening is obtained with a longitudinal rib (11).

5. The stamped tab, as claimed in claims 1 and 4, characterized by the fact that the elongated stiffening is obtained with a longitudinal rib (11) in which a central groove and two swells (26) on the plate, adjacent to the groove, are combined.

6. The stamped tab, as claimed in claim 1, characterized by the fact that the elongated stiffening is obtained with a longitudinal draw (12).

7. The stamped tab, as claimed in claim 1, characterized by the fact that the stiffening of tab (1) is obtained with a longitudinal draw (7) and with a draw (8), which is transversal to the axis of the tab (1) and placed on the plate (2).

8. The stamped tab, as claimed in claims 1 and 7, characterized by the fact that the stiffening of tab (1) is obtained with a longitudinal draw (7) and with a draw (8), which is transversal to the axis of the tab (1) and has an opening (9) adjacent to the transversal draw (8) on the plate (2).

9. The stamped tab, as claimed in claim 1, characterized by the fact that, if there is no protective insulating coat on the plate (2), the body of the tab (1), below the longitudinal stiffening, has a shaped level profile if compared with the level of the plate (2) from where the tab (1) emerges, with at least one part protruding (10) towards the point where the electrical contact with another tab or plate is foreseen.

10. The stamped tab, as claimed in claim 1, characterized by the fact that, when there is an electrically insulating protective coat (25) only on one side of the plate (2), the tab (1) is bent over at 180° (a “U” bend) at its free end, so that both external surfaces are conductive.

11. The stamped tab, as claimed in claim 1, characterized by the fact that, when there is at least an electrically insulating protective coat (25) on one or both sides of the plate (2), the tab (1) has a drawn hole (14) on its free end, and its upper metal edge (15) is not protected by any insulating coat (25).

12. The stamped tab, as claimed in claims 1 and 111 characterized by the fact that the hole (14) and the upper edge (15) tend to have a polygonal profile.

13. The stamped tab, as claimed in claim 1, characterized by the fact that, at least when there is an electrically insulating protective coat (25) on one or both sides of the plate (2), the tab (1) has, towards its free end, at least a stretched and compressed cut (20), and the most protruding parts of said deformation being electrically conductive.

14. The stamped tab, as claimed in claims 1, 11, 12 and 13, characterized by the fact that the hole (14) and the stretched and compressed tear (20) can have any edge profile.

15. The stamped tab, as claimed in claim 1, characterized by the fact that, at least where there is an electrically insulating protective coat (25) on one or both sides of the plate (2), the tab (1) has towards its free end, a conic or dome-like deformity of the plate whose tip is stressed, stretched and/or compressed so as to make the protective insulating coat (25) come off on that spot.

16. The stamped tab, as claimed in claim 1, characterized by the fact that the deformation of the metal with which the elongated stiffening of the tab (1) is obtained and the deformation with which the electric contact points towards the end of the tab (1) are obtained, can be combined in any way with each other.

17. The stamped tab, as claimed in the previous claims, characterized by the fact that tab (1) protrudes from the level of the plate (2) from which it is obtained.

18. The stamped tab, as claimed in the previous claims, characterized by the fact that tab (1) protrudes from the edge of the level where the plate (2) ends.

19. The stamped tab, as claimed in the previous claims, characterized by the fact that tab (1) is placed inside an opening made on the plate (2) and it is trimmed on three sides.
